(19) United States
(12) Patent Application Publication
(10) Pub. No.: US 2005/0073841 A1
(43) Pub. Date: Apr. 7, 2005

(54) Light source apparatus

(75) Inventor: Kenji Imamura, Hyogo (JP)

Correspondence Address: RADER FISHMAN & GRAUER PLLC, LION BUILDING, 1233 20TH STREET N.W., SUITE 501, WASHINGTON, DC, 20036, US

(73) Assignee: USHIO DENKI KABUSHIKI KAISHA

(21) Appl. No.: 10/959,079

(22) Filed: Oct. 7, 2004

(30) Foreign Application Priority Data
Oct. 7, 2003 (JP) 2003-347982

(51) Int. Cl. F21K 2/00

(52) U.S. Cl. 362/264

(57) ABSTRACT

An object of the invention is to provide a light source of a projector apparatus used in floor use and ceiling use, wherein in either use, a discharge lamp and a concave reflecting mirror can be efficiently and sufficiently cooled. A light source apparatus for a projector capable of being used in a floor use and in a ceiling use, comprises a discharge lamp having a neck portion and a light emitting portion, a concave reflecting mirror having a neck portion, in which the discharge lamp is disposed in the neck portion of the concave reflecting mirror, and a ventilation member having at lease one ventilation opening in which cooling air from the upper side ventilation opening passes along the light emitting portion of the discharge lamp so as not to directly blow the light emitting portion and directly blows a mirror face of the concave reflecting mirror.

### FIELD OF THE INVENTION

The present invention relates to a light source apparatus, and more specifically, to a light source apparatus for a DLP projector apparatus or a liquid crystal projector apparatus, which can be not only placed on a floor but also hung from a ceiling.

### DESCRIPTION OF THE RELATED ART

In recent years, needs to display an image on a large screen of a personal computer or a television for use in presentation for business, and school classes, or as data at a meeting, are increasing. In order to work with these needs, a projector apparatus is used, and there are two types of projector apparatuses, that is, liquid crystal panel type projector apparatuses and DLP type projector apparatuses.

In the crystal liquid panel type projector apparatuses, after radiation light from a light source is separated into three colors (RGB), transmission adjustment of light is carried out on each liquid crystal panel according to image information, and then the three colors which pass through respective panels are synthesized, so as to project an image on a screen.

On the other hand, in the DLP type projector apparatuses, radiation light from a light source is irradiated to a DMD (Digital Micro Mirror Device) through a rotation filter in which divided RGB areas are formed, and specific light is reflected so as to irradiate it onto a screen by the DMD. The DMD comprises millions of small mirrors, each of which corresponds to each pixel, wherein projection of light is controlled by controlling the direction of each small mirror. As a light source for these projector apparatuses, a discharge lamp such as a metal halide lamp, an extra-high pressure mercury lamp and the like is used. The radiation light from such a discharge lamp is condensed by a concave reflecting mirror, and is treated so that illuminance on a screen becomes uniform by a various optical lens(es) such as an integrator lens etc., whereby it is irradiated to a liquid crystal face.

For example, the pressure in an arc tube of a short arc type discharge lamp at time of lighting is set to high such as 20-150 atm in order to improve spectral characteristics. In order to bring into such a high operating pressure state, it is necessary to evaporate completely the mercury enclosed, so that it becomes a condition to raise the temperature of the lowest temperature portion of a light emitting portion of the discharge lamp. Further, if temperature thereof is extremely raised too much, silica glass causes undesirable devitrification, so that cooling air (wind) etc. is usually used. Furthermore, the arc tube can also be deteriorated and damaged within life time which is usually required as a discharge lamp. Moreover, glass fragments of the discharge lamp, which has been raised to high temperature, are scattered to an optical system or a power supply portion etc. provided in the projector apparatus, so that they are deteriorated or messed up, whereby use of light transmitting portions becomes impossible, it becomes difficult to repair them, or a very loud explosion sound occurs.

A projector is known, wherein a front side opening of a concave reflecting mirror is covered by a light transmitting glass (optically transparency glass) so that the fragments are not scattered outside the projector even if the discharge lamp is destroyed while the discharge lamp is lighted up, and the explosion sound is eliminated by covering with the light transmitting glass. In such a projector, since the inside of the concave reflecting mirror is in a sealed state so that the inside of the reflecting mirror is raised to very high temperature at time of lighting although there are effects against breakage of the lamp and the elimination of explosion sound if the front side opening of the concave reflecting mirror is covered by the light transmitting glass. Specifically a light emitting portion or a sealed portion of the discharge lamp becomes high temperature beyond necessity, whereby devitrification is caused in the arc tube, and cracks are caused by oxidization and expansion of metallic foil in the sealed portion. Moreover, when the specular surface temperature (the mirror face temperature) of the reflecting mirror becomes high beyond necessity, the heat-resistant temperature of the vapor-deposited film is exceeded, or when a big difference of temperature is produced between the inner face and outer face of the reflecting mirror, heat deterioration such as cracks etc. of the vapor-deposited film, or large cracks due to the heat to the reflecting mirror may occur.

For this reason, the structure introducing a cooling air (wind) into the concave reflective mirror is proposed in which the front opening of the concave reflecting mirror is covered with light transmitting glass, and a notch for ventilation is provided in part of the front side opening. In this case, a flow path in which the cooling wind (air) passes through is formed inside the concave reflecting mirror by providing an exhaust opening (air discharging opening) in a neck portion of the concave reflecting mirror.

Such a structure is disclosed in Japanese Laid Open Patent Nos.10-223023, 10-326520, and 11-39934, etc.

The discharge lamp which is built in such a kind of projector apparatus is usually arranged horizontally in many cases, and in any of the above-mentioned references, the structure of the discharge lamp in which the discharge lamp is also arranged horizontally is shown.

However, when the discharge lamp is arranged horizontally, an upper portion of the discharge lamp is raised to relatively high temperature, in comparison with a lower portion of the discharge lamp and the concave reflecting mirror. Since especially the inside of the above-mentioned concave reflecting mirror is approximately sealed, a high temperature rise in the upper portion cannot be avoided although the cooling wind (air) flows from part of the opening.

For this reason, a ventilation hole is in general provided, mainly focusing on the upper portion, in order to attain equalization of temperature rather than to uniformly and directly wind the concave reflecting mirror or the discharge lamp so as to cool them. Moreover, since the discharge lamp has portions such as a light emitting portion and sealing portions to be cooled individually intensely, a cooling air sending hole (ventilation hole) having directivity to these portions is designed.

On the other hand, various uses of such a projector apparatus is called for recently. Specifically it is required that such a projector apparatus can be both placed on a floor or a desk, and hung from a ceiling so as to use it in either way. Especially, when the projector is operated in the ceiling use, as compared with the floor use, the projector apparatus must be set up upside down. Therefore, upper portions of a discharge lamp or a concave reflecting mirror which is subject to the high temperature rise will also be reversed. That is, the structure for the floor use for forcing to cool the upper position of the discharge lamp or the concave reflecting mirror, forces to cool the lower portion of the discharge lamp or the concave reflecting mirror in the ceiling use, whereby it is likely to cause high temperature rise in the upper portion.

In order to solve the above-mentioned problem, it is proposed that a cooling air (wind) sending hole is provided on only a side portion of the concave reflecting mirror so as to cool the discharge lamp or the concave reflecting mirror by the cooling air having directivity, and to discharge the air from a neck portion of the reflecting mirror. (Refer to Japanese Laid Open Patent No. 2001-183745.

Such a structure may solve the above problem by changing a use form, since cooling from the side portion is carried out in either the floor use or ceiling use.

However, this structure is not to solve the problem that the upper portion of the discharge lamp and the concave reflecting portion are raised to relatively higher temperature than the lower portion. That is, in either the floor use or the ceiling use, there remains the problem that the upper portion of the discharge lamp and the concave reflecting portion are raised to relatively high temperature. In particular, in recent years, projector apparatuses are miniaturized more and more whereby the inside of the apparatuses is crowded with various parts. Moreover, improvement in brightness of the discharge lamp itself is required. That is, although the entire apparatus is miniaturized so that inside thereof is crowded with the various parts, a light source, which is the greatest source of heat generation, tends to be raised to higher temperature.

Moreover, it can be considered that the flow of cooling air (wind) is changed by a mechanical structure, depending on the use form, that is, the ceiling use or the floor use. In this case, in either the floor use or the ceiling use, it becomes possible to cool intensively the portions which are raised to high temperature. However, while the entire projector apparatus is miniaturized as mentioned above and the parts contained inside are crowded, it is not desirable to attach such mechanical structure therein.

### SUMMARY OF THE INVENTION

It is an object of the present invention to provide a light source used in a projector apparatus which can be both placed on a floor and hung from a ceiling, wherein in either use, it is possible to efficiently and sufficiently cool a discharge lamp and a concave reflecting mirror.

In order to solve the above-mentioned problems, the object of the present invention is achieved by a light source apparatus for a projector capable of being operated in floor use and in ceiling use, in which a discharge lamp having a light emitting portion is horizontally disposed in a neck portion of a concave reflecting mirror whose front face opening is covered by light transmitting glass and an optical axis L of the concave reflecting mirrors is approximately in agreement with an arc direction of the discharge lamp, wherein mercury of 0.15 mg/mm³ or more is enclosed in the discharge lamp, a ventilation hole is provided in one side portion of the front face opening of the concave reflecting mirror, and an air discharging hole is provided in other side portion of the front face opening of the concave reflecting mirror, and the ventilation hole comprises an upper side ventilation opening in which cooling air from the upper side ventilation opening passes above the light emitting portion of the discharge lamp so as not to directly blow the light emitting portion, and directly blows a mirror face of the concave reflecting mirror, and a lower side ventilation opening in which cooling air from the lower side ventilation opening passes below the light emitting portion so as not to directly blow the light emitting portion of the discharge lamp, and directly blows the mirror face of the concave reflecting mirror.

In the light source apparatus, the ventilation hole may be provided in a ventilation member which fits in an edge of the front face opening of the concave reflecting mirror.

Even if the projector apparatus in which the light source apparatus according to the present invention is installed, is operated in either floor use or a ceiling use, it is possible to sufficiently cool the discharge lamp and the inside of the concave reflecting mirror.

### BRIEF DESCRIPTION OF THE DRAWINGS

FIG. 1 is an explanatory schematic view of a light source apparatus according to the present invention;

FIG. 2A is a side elevational view of the light source apparatus to which a ventilation fan is attached, showing arrows IIB and IIC;

FIG. 2B is a top plan view thereof, viewing in the direction of the arrow IIB shown in FIG. 2A;

FIG. 2C is a front elevational view thereof, viewing in the direction of the arrow IIC shown in FIG. 2A;

FIG. 3 is a diagram for explaining the flow of the cooling air inside the concave reflecting mirror;

FIG. 4A is an enlarged view of the ventilation member 40 shown in FIGS. 1-3;

FIG. 4B is another embodiment of the ventilation member;

FIG. 5 is an enlarged view of the discharge lamp for the light source apparatus according to the present invention;

FIG. 6A is a side elevational view of a projector having the light source apparatus according to the present invention in operation, wherein the projector is place on a floor (ground) in a floor use and an image is projected onto a screen; and

FIG. 6B is a side elevational view thereof in operation, wherein the projector is hung from a ceiling and an image is projected on to a screen.

### DESCRIPTION OF THE PREFERRED EMBODIMENTS

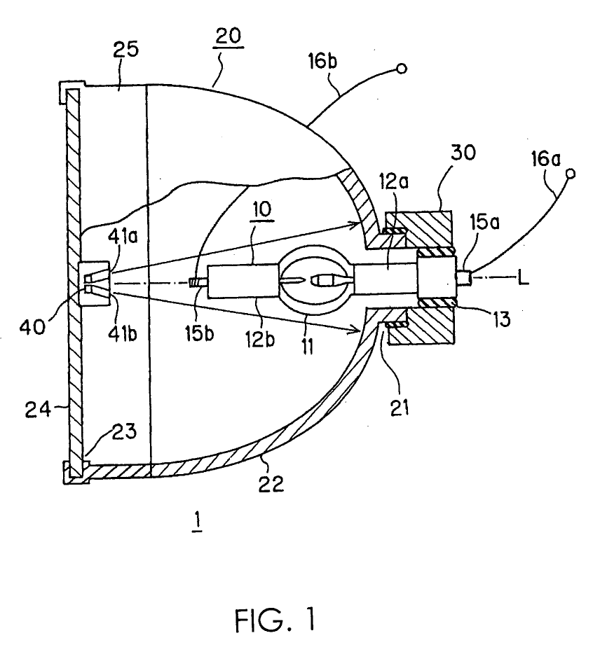

FIG. 1 is an explanatory schematic view of a light source apparatus according to the present invention.

A light source apparatus comprises a short arc type high pressure discharge lamp 10 (hereinafter referred to as “a discharge lamp”) and a concave reflecting mirror 20 surrounding the discharge lamp 10, and is arranged so that the arc luminescent spot of the discharge lamp 10 is in agreement with the merdional focus of the concave reflecting mirror 20, while the optical axis L of the concave reflecting mirrors 20 is approximately in agreement with the arc direction of the discharge lamp 10.

The discharge lamp 10 comprises an approximately spherical shape light emitting portion 11 and rod shape sealing portions 12a and 12b which are connected to the both end of the light emitting portion 11, and further a pair of electrodes facing each other is disposed in the light emitting portion 11. The sealing portion 12a of the discharge lamp 10 is inserted in an opening of a top portion (neck portion) of the concave reflecting mirror 20, and a mouthpiece which is attached to the tip of the sealing portion 12a is attached through adhesive 13 to a lamp holding member 30. Moreover, the outer circumference of the neck portion of the concave reflecting mirror 20 and the lamp holding member 30 are connected through the adhesive.

An electric supply lead 15a is projected from the tip of the sealing portion 12a, and electrically connected through an electric supply line 16a to an electric power supply apparatus (not shown). On the other hand, an electric supply lead 15b is also projected at the tip of the sealing portion 12b, and an electric supply line 16b is extended to the outside through an opening of the concave reflecting mirror 20 so as to be connected to the electric power supply apparatus. The concave reflecting mirror 20 is a bowl-like ellipse condensing mirror as a whole, and the concave reflecting mirror 20 comprises the tip portion 21 and a reflecting portion 22. The concave reflecting mirror 20 is made of, for example, borosilicate glass or crystallization glass, etc. While the visible light reflex layer made of, for example, titanium oxide and oxide silicon is formed in the inside of the reflecting portion 22 and the light of visible wavelength band is reflected and light other than that, such as infrared light is absorbed in the reflective portion 22. A cylindrical frame member 25 is attached to a front opening of the concave reflecting mirror 20. The frame member 25 is made of heat-resistant resin such as PPS (Poly Phenylene Sulfide) etc., wherein a glass holding portion 23 thereof holds light transmitting glass (optically transparency glass) 24, so that light is blocked and the glass holding portion 23 is protected. The light transmitting glass 24 is, for example, borosilicate glass etc., which transmits direct light from the discharge lamp 10, or light reflected on a reflective portion 22 of the concave reflecting mirror 20. In addition, in order to avoid direct light from the discharge lamp 10, for example, a stainless thin plate (film) is formed on the inner face of the frame member 25. Moreover, except for the ventilation hole and an air discharging hole which are mentioned later, the interior space of the concave reflecting mirror 20 becomes an almost sealed structure by disposing the light transmitting glass 24. For this reason, when a discharge lamp 10 is damaged or destroyed, it is possible to prevent fragments from scattering. Furthermore, sound made at the time of the breakage can be eliminated or reduced. In addition, the light transmitting glass (optically transparent glass) 24 may be plane glass as shown in the figure, or may be a concave lens which changes the light reflected on the concave reflecting mirror 20 to parallel light. A ventilation member 40 is attached on a side portion of the frame member 25. This ventilation member 40 has ventilation holes 41 (41a, 41b) which have such directivity that the reflecting portion 22 gets directly cooling air (wind) which is introduced from the outside through the ventilation holes 41 but the light emitting portion 11 of the discharge lamp does not get the cooling air directly. Moreover, although not shown in FIG. 1, the air discharging hole 42 for the cooling air is provided on the other side of the frame member 25. Therefore, the cooling air (wind) introduced from the ventilation hole 41 of the ventilation member 40 blows the reflecting portion 22 of the concave reflecting mirror 20 directly, and then is discharged from the air discharging hole 42. In addition, the frame member 25 (especially the cylinder portion) is not indispensable. For example, it is possible to directly attach the light transmitting glass to the front opening of the concave reflecting mirror 20 or it is also possible to provide such a frame member to the extent that the light transmitting glass can be held so as to omit the cylindrical member. In this case, the ventilation member 40 is attached to a notch(s) of the concave reflecting mirror 20 etc.

In the present invention, the meaning of “the ventilation member 40 fits in the front face opening edge portion of the concave reflecting mirror 20” includes the meaning of “fitting in the edge portion of the frame member 25 when the frame member 25 is attached to the front face opening of the concave reflecting mirror 20.

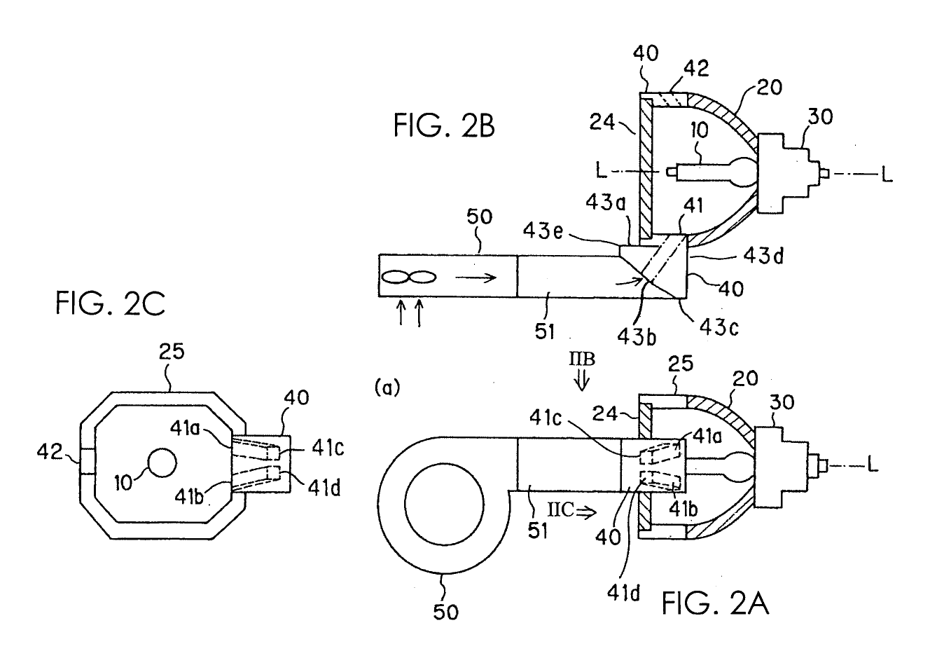

FIG. 2A is a side elevational view of the light source apparatus to which a ventilation fan 50 is attached, showing arrows IIB and IIC. FIG. 2B is a top plan view thereof, viewing in the direction of the arrow IIB shown in FIG. 2A. FIG. 2C is a front elevational view thereof, viewing in the direction of the arrow IIC shown in FIG. 2A. The ventilation member 40 is attached to a blowoff opening of a ventilation fan 50 through a duct 51, and this ventilation member 40 is attached on one side portion of the frame member 25. Moreover, the air discharging hole 42 is formed on the another side portion of the frame member 25 (in this example, on the opposite side). The ventilation member 40 is provided so as to fit in a notch(s) formed in the frame member 25. On the other hand, the air discharging hole 42 is provided by forming an opening in the frame member 25. The ventilation fan 50 is, for example, a sirocco type fan, and airflows the inside of the concave reflecting mirror 20 from the ventilation member 40 through the duct 51. The ventilation fan 50 is not limited to the form of illustration. However, the cooling air (wind) can be efficiently introduced to the concave reflecting mirror inside the narrow and crowded projector apparatus, by using a long and slender duct as shown.

The ventilation member 40 has the ventilation holes 41 comprising the upper side ventilation opening 41a and the lower side ventilation opening 41b. The upper side ventilation opening 41a controls the cooling air not to directly blow the light emitting portion 11 of the discharge lamp 10 but to pass above the light emitting portion 11 so as to directly blow the reflecting portion 22 of the concave reflecting mirror 20. Similarly, the lower side ventilation opening 41a controls the cooling air not to directly blow the light emitting portion 11 of the discharge lamp 10 but to pass below the light emitting portion 11 so as to directly blow the reflecting portion 22 of the concave reflecting mirror 20. In FIG. 2B, 43a-43e denote side faces of the ventilation member 40. Strictly speaking, since, in fact, the cooling air which is blown off from the ventilation hole 41 has a spread to some extent, the cooling air (wind) may have components which directly blow the light emitting portion 11. However, in the present invention, it is meant that the virtual extension of the ventilation holes 41 (41a, 41b) do not blow the light emitting portion of the discharge lamp 10. In case that there is some depth in the direction of wind flow, the virtual extension can be formed by extending the depth. In addition, as long as the virtual extension of the ventilation hole 41 does not blow the light emitting portion 11 of the discharge lamp 10, it is acceptable, and the extension does not need to pass very close to the light emitting portion 11. That is, the upper side ventilation opening 41a and the lower side ventilation opening 41b may have a large angle to the optical axis L.

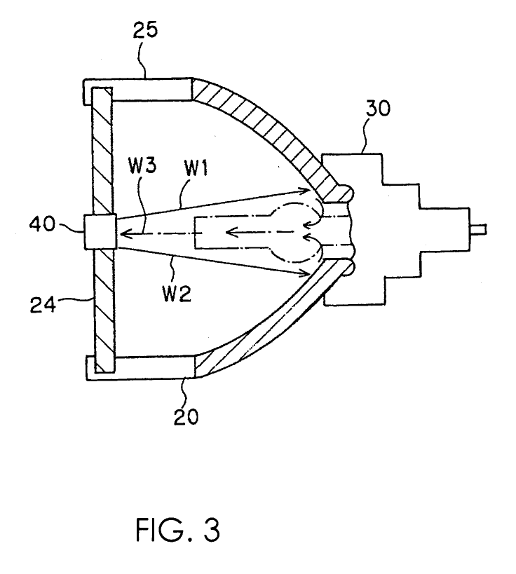

FIG. 3 is a diagram for explaining the flow of the cooling air inside the concave reflecting mirror 20.

Part of the cooling air introduced from the ventilation hole of the ventilation member 40 passes above the light emitting portion of the discharge lamp so as to directly blow an inner face of the reflecting mirror as shown in an arrow W1 in FIG. 3, and another part of the cooling air passes below the light emitting portion of the discharge lamp so as to directly blow the inner face of the reflecting mirror as shown in an arrow W2 in FIG. 3.

After that, the air gathers near the connecting portion of the light emitting portion 11 and the sealing portion 12a. Or, the cooling air introduced from the ventilation hole, passes along the curved inner face of the reflecting mirror so as to gather around the neck portion. And by cooling the central part (the root of the sealing portion 12) of the light emitting portion 11, the upper portion of the light emitting portion 11 is cooled down by heat conduction so as to bring the temperature of the upper portion close to the temperature of the central part of the light emitting portion 11.

Similarly, the temperature of the lower part of the light emitting portion 11 is also brought close to the temperature of the central part of the light emitting portion 11 by heat conduction. In FIG. 3, the light emitting portion 11 and the sealing portion 12 are not shown. For these elements, refer to FIG. 1. Furthermore, after that, the cooling air (wind) gathering in the central part of the light emitting portion 11 is discharged from the air discharging hole after passing along the center side portion of the light emitting portion 11. Some components of the cooling air are diffused in the upper portion of the light emitting portion 11 so that the upper portion can be cooled down more than the lower portion. Since the cooling air flows so as not to directly blow the lighting portion 11 of the discharge lamp as shown in the arrows W1 and W2, the upper and lower portions of the discharge lamp are not cooled down locally. Moreover, the cooling air (wind) dose not include a large component which flows to the lower portion, and the light emitting portion 11 is designed to be cooled down by convection due to the diffusion of the cooling air. For this reason, the temperature difference between the upper portion and the lower portion of the light emitting portion 11 becomes small, and in either floor use or ceiling use, not only is the temperature difference therebetwee small, but the amount of change can also be made small. Of course, according to the present invention, although some components of the cooling air may not flow as mentioned above, the above described flow of the cooling air becomes dominant so that it is possible to attain the above effects, as clear from experimental results described later.

Here, one of the features of the present invention is that the neck portion 21 of the concave reflecting mirror 20 does not have any air discharging mechanism.

That is, the neck portion of the concave reflecting mirror, the sealing portion and the mouthpiece of the discharge lamp, and the lamp holding member have the structure in which gaps therebetween are filled with adhesive or filler so that the air does not flow. Or, even though there exist some gaps or openings, no structure positively using these gaps or opening for ventilation is formed. For this reason, supercooling of the sealing portion located on the side of the neck portion 21 of the concave reflecting mirror 20, that is, the sealing portion 12a in FIG. 1 can be prevented. And it is possible to prevent a problem that mercury is not evaporated, thereby preventing problems of flicker or illuminance instability of the discharge lamp. Moreover, the present invention also has a feature that the ventilation hole and the air discharging hole is formed on the side portion of the concave reflecting mirror. According to the above-mentioned feature, it is possible to reduce temperature difference in the discharge lamp or the concave reflecting mirror as much as possible, and also even though the light source is turned upside down by 180 degrees when changing the use form between the floor use and the ceiling use, it is possible to reduce the temperature difference in the discharge lamp or the concave reflecting mirror, as well.

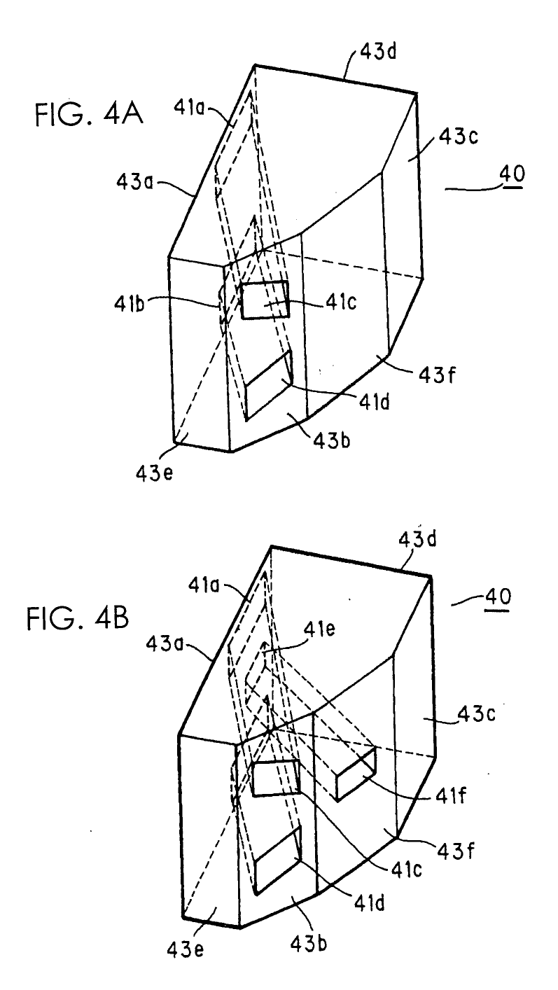

FIG. 4A is an enlarged view of the ventilation member 40 shown in FIGS. 1-3. FIG. 4B is another form of the ventilation member 40.

In FIG. 4A, the ventilation member 40 is, for example, one piece component made of steatite and a octahedron having 6 side faces 43a, 43b, 43c, 43d, 43e, and 43f.

The side face 43a is arranged in contact with the frame member 25, and the upper side ventilation opening 41a and the lower side ventilation opening 41b are formed thereon.

The side faces 43b and 43f fit in the end portion of the duct 51, and an inlet 41c and an inlet 41d are formed on the side face 43b. The side face 43c is parallel to the side face 43a. That is, with the arrangement relation between the concave reflecting mirror 20 and the ventilation fan 50, the cooling air flowing in the duct 51 is turned toward the inside of the concave reflecting mirror 20 in the ventilation member 40. The side faces 43d and 43e are perpendicular to the flowing direction of the cooling air flowing inside the duct 51. And a vent is formed from the inlet 41c toward the upper side ventilation opening 41a, and similarly, a vent is formed from 41d toward the lower side ventilation opening 41b. The angle of these vents forms the directivity to the reflective portion 22 of the concave reflecting mirror 20.

In FIG. 4B, another embodiment of the ventilation member 40 is shown, wherein in addition to the upper side ventilation opening 41a and the lower side ventilation opening 4b, a central ventilation opening 41e and an inlet 41f therefor are provided.

Although the inlet 41f may be formed on the same side face as that of the inlets 41c and 41d, in this embodiment, it is formed on a different side face from that of the other inlets, taking into consideration the ease of manufacture processing etc. Thus, by forming the central ventilation opening 41e, it is possible to cool the sealing portion located on the front face opening side of the concave reflecting mirror 20, that is, in FIG. 1, the cathode side sealing portion 12b. However, when forming the central ventilation hole 41e, caution must be paid so as not to disturb the above-mentioned flow of the cooling air in the concave reflecting mirror 20.

The ventilation member 40 is not limited to the structure shown in FIG. 4. Although in FIGS. 4A and 4B, the ventilation member 40 is a octahedron having 6 side faces because of the arrangement of the ventilation fan 50 and the duct 51, as the ventilation member 40, the structure of a cube and a rectangular parallelepiped which has four sides, and others may be adopted. Moreover, the position and the number of the ventilation holes or the inlets are not limited to those shown in FIG. 4. The ventilation member 40 is not necessarily attached to the frame member 25, but may fit into the notch of the front opening edge of the concave reflecting mirror 20, or a notch(s) formed in light transmitting glass 24. Moreover, the ventilation member 40 is not limited to one piece component as shown in the figures. It may be integrally formed with the frame member 25 or it may be formed as part of the frame member 25 and further, it may be integrally formed with the concave reflecting mirror or it may be formed as part of the concave reflecting mirror 25. In these cases, the ventilation member 40 is not necessarily one component physically. However, in the ventilation member 40, the directivity for making the cooling air to be sent, blow the reflecting portion directly, almost without directly blowing the light emitting portion of the discharge lamp is required. Therefore, it is desirable to adopt a physically separate component as the ventilation member in the meaning that it is possible to design directivity with sufficient accuracy.

As a numerical example of the ventilation member 40, the width, height, and depth thereof are 25 mm, 22 mm and 20 mm respectively, assuming that the rectangular parallelepiped formed by the side faces 43a and 43d. The width means the dimension in the direction in which the side face 43a extends, and the depth means the dimension in the direction in which the side face 43d extends. The opening area of the upper side ventilation opening 41a or the lower side ventilation opening 41b is 15%-40% of a cross-section area of the light emitting portion 11, that is, numerically, it is about 24 mm². Moreover, the angle formed by the upper side ventilation opening 41a or the lower side ventilation opening 41b and the arc axis L of the discharge lamp is chosen from the range of 35 to 60 degrees, for example, 50 degrees. It is possible to cool suitably the central part (neck portion) of the concave reflecting mirror 20 by adopting such an angle range.

An air discharging hole 42 is formed on the side portion opposite to the ventilation hole 41. Although it is desirable to make the ventilation member 40 having the ventilation hole 41 from a physically independent member as described above, the air discharging hole 42 can be prepared by simply forming a notch(s) in the frame member or the concave reflecting mirror. This is because only a function for discharging the cooling air is required for the air discharging hole 42.

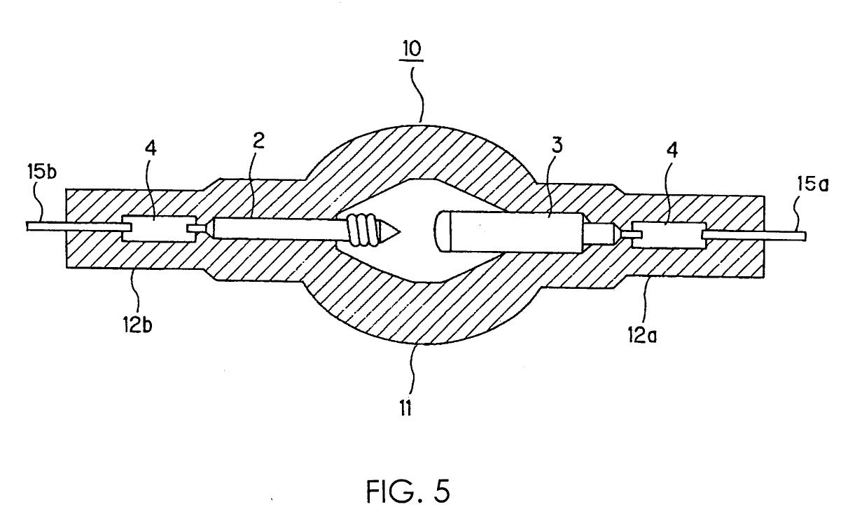

FIG. 5 is an enlarged view of the discharge lamp for the light source apparatus according to the present invention.

The discharge lamp 10 has the light emitting portion 11 having an approximately spherical shape, which is formed with the electric discharge container made of silica glass, wherein an anode 2 and the cathode 3 are disposed so as to face each other in the light emitting portion 11. Moreover, the sealing portions 12 (12a, 12b) are respectively formed so that they extend from the both ends of the light emitting portion 11, and the metallic foils 4 for electric conduction, which are usually made of molybdenum, are airtightly laid in the respective sealing portions 12 by, for example, shrink sealing. The anode 2 and the cathode 3 are connected to the respective ends of the metallic foil 4, and the other ends of the metallic foil 4 are connected to the respective external leads 16. A coil 31 is wound around the tip of the cathode 3. The coil 31 is made of tungsten, and is welded or firmly wound around the cathode 3. While the coil 31 functions as a source of starting (starting position) according to a surface concavo-convex effect at the time of lighting initiation, it has a heat dissipation function according to the surface concavo-convex effect and the heat capacity after lighting. In addition, in FIG. 1, although the sealing portion 12a on the anode side is attached to the neck portion 21 of the concave reflecting mirror 20, the sealing portion 12b on the cathode side may be attached to the neck portion 21 of the concave reflecting mirror 20.

In the light emitting portion 11, mercury, rare gas, and halogen gas are enclosed. Mercury of 0.15 mg/mm³ or more, more preferably, 0.25 mg/mm³ or more is enclosed therein to obtain radiation light of necessary visible light wavelength, for example, 360-780 nm wavelength. Although this amount of enclosure changes depending on the temperature conditions, it serves as very high vapor pressure with 150 or more atmospheric pressure at the time of lighting. Moreover, it is possible to make a high mercury vapor pressure discharge lamp whose mercury vapor pressure is 200 or more atmospheric pressure, or 300 or more atmospheric pressure at lighting by enclosing much more mercury, so that it is possible to realize a light source suitable for a projector apparatus, as the mercury vapor pressure becomes high. Rare gas, for example, argon gas of about 13 kPa is enclosed thereby improving the lighting starting nature. Halogen is enclosed in form of a compound of mercury or other metals and iodine, bromine, chlorine, etc. The enclosing amount of halogen is selected from the range of, for example, 10⁻⁶ to 10⁻² μmol/mm³. Although the function of the halogen is to extend the life time of the discharge lamp by the halogen cycle, it is thought that in case of an extremely small discharge lamp with high inner pressure as the discharge lamp according to the present invention, there are advantages that the enclosure of halogen prevents devitrification or destruction of the discharge container.

As a numerical example of such a discharge lamp, for example, the outer diameter of the light emitting portion is chosen from the range of ψ9.0-12.0 mm, such as 10.0 mm, and the distance between electrodes is chosen from the range of 0.5-2.0 mm, such as 1.5 mm, and the arc tube internal volume is chosen from the range of 40-300 mm³, such as 75 mm³. As the lighting conditions, for example, the tube wall load is selected from the range of 0.8-2.0 W/mm² such as 1.5 W/mm², and rated voltage and rated-apparent-power are 80 V and 200 W, respectively.

Moreover, this discharge lamp is built in a projector apparatus etc. to be miniaturized, and while the entire structure is miniaturized extremely, the high intensity light is required. Therefore, the thermal conditions of the inside of the light emitting portion becomes very severe. And a discharge lamp is disposed in an apparatus for presentations like a projector apparatus or an overhead projector, in which radiation light with good color rendering nature is provided.

As a numerical example about the concave reflecting mirror 20, for example, the internal volume is selected from the range of 3×10⁴ to 15×10⁴ mm³ such as 7.5×10⁴ mm³, and the thickness of the reflecting portion is selected from the range of 3-6 mm, for example, 4 mm, and the diameter of the front face opening is chosen from the range of ψ38-55 mm, for example 50 mm, and the length from the front face opening to the focal point (center of the distance between electrodes) in the direction of the axis is chosen from the range of 20-50 mm, for example, 40 mm. The inner diameter of the neck portion is preferably 0.8-1.2 times of the outer diameter of the light emitting portion. As a numerical example of the front glass 24, the thickness is chosen from the range of 3-5 mm, for example, 4 mm.

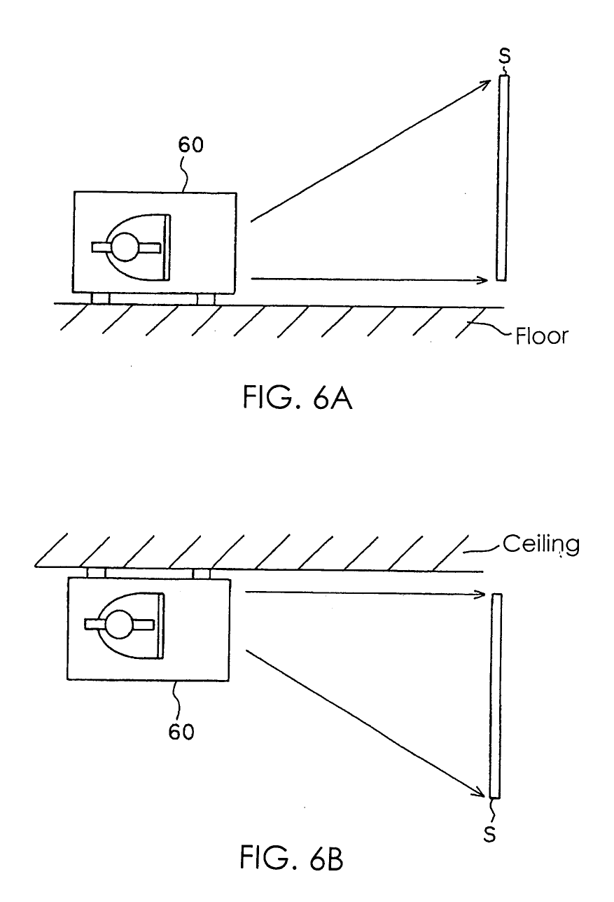

FIG. 6A is a side elevational view of a projector having the light source apparatus therein according to the present invention in operation, wherein the projector is place on a floor (ground) in a floor use and an image is projected onto a screen S.

FIG. 6B is a side elevational view thereof in operation, wherein the projector is hung from a ceiling and an image is projected on to a screen.

In FIGS. 6A and 6B, the same projector apparatus is shown, wherein the projector apparatus 60 is turned upside down and the projected image is also turned upside down so that the projector apparatus can be operated both in the floor use and in the ceiling use. And in the light source apparatus according to the present invention, since the cooling air does not directly blow the light emitting portion of the discharge lamp, the light emitting portion of the discharge lamp is not locally cooled down either in the floor use or in the ceiling use.

Next, the experimental result of the light source apparatus according to the present invention is explained.

As the light source apparatus according to the present invention, the light source apparatus shown in FIGS. 1, 2, and 3 was used, and for comparative purposes, a light source apparatus in which only the ventilation hole and the air discharging hole of the ventilation member differed was used. The light source apparatus for comparison was the same as the light source apparatus according to the present invention except that a ventilation hole which makes the cooling air blow the center of the light emitting portion of the discharge lamp was provided on a side portion of the frame member and an air discharging hole was provided on the neck portion of the concave reflecting mirror. In this experiment, temperature sensors were attached to the upper portion and the lower portion of the light emitting portion of the discharge lamp respectively, and the temperature of the light emitting portion was measured in each use, that is, the floor use and the ceiling use. The ventilation member of the light source apparatus according to the present invention had two ventilation holes whose height and width are 6 mm and 4 mm respectively, which corresponded to 41a and 41b shown in FIG. 4A, and the conventional light source apparatus for comparison had one ventilation hole whose height and width is 6 mm and 10 mm respectively. Moreover, a sirocco fan was used as a ventilation fan and air at a speed of 4 m/sec. was sent to the ventilation hole(s) of the ventilation member. The discharge lamp described above as a numerical example and shown in FIG. 1 was used. An experimental result is shown below.

TABLE 1

| Light source | | Light source | |
|---|---|---|---|
| apparatus of this | | apparatus for | |
| invention | | comparison | |
| Floor Use | Ceiling Use | Floor Use | Ceiling Use |
| Upper Portion of | Upper Portion of | Upper Portion of | Upper Portion |
| Light Emitting | Light Emitting | Light Emitting | of Light |
| Portion: | Portion: | Portion: | Emitting |
| 1000 degrees C. | 995 degrees C. | 1000 degrees C. | Portion: |
| | | | 988 degrees C. |
| Lower Portion of | Lower Portion of | Lower Portion of | Lower Portion |
| Light Emitting | Light Emitting | Light Emitting | of Light |
| Portion: | Portion: | Portion: | Emitting |
| 872 degrees C. | 873 degrees C. | 834 degrees C. | Portion: |
| | | | 848 degrees C. |
| Temperature | Temperature | Temperature | Temperature |
| Difference: | Difference: | Difference: | Difference: |
| 128 degrees C. | 122 degrees C. | 166 degrees C. | 140 degrees C. |

In the above described experimental results, in case of the floor use of the light source apparatus according to the present invention, the temperature of the upper portion of the light emitting portion was 1000 degrees Celsius and that of the lower portion of the light emitting portion was 872 degrees Celsius so that temperature difference therebetween was 128 degrees. In addition, in case of the ceiling use, the temperature of the upper portion of the light emitting portion was 995 degrees Celsius and that of the lower portion of the light emitting portion was 873 degrees Celsius so that temperature difference therebetween was 122 degrees.

On the other hand, in case of the floor use of the light source apparatus for comparison, the temperature of the upper portion of the light emitting portion was 1000 degrees Celsius and that of the lower portion of the light emitting portion was 834 degrees Celsius so that temperature difference therebetween was 166 degrees, and in addition, in case of the ceiling use of the light source apparatus for comparison, the temperature of the upper portion of the light emitting portion was 988 degrees Celsius and that of the lower portion of the light emitting portion was 848 degrees Celsius so that temperature difference therebetween was 140 degrees. While the above-mentioned value was measured when the temperature was stabilized after the discharge lamp is lighted and at the same time ventilation fan was started. This stable value was measured 10 minutes after the initiation of the lighting, and although there was some change, the temperature value was approximately constant.

From the above-mentioned measurement results, it is understood that in the light source apparatus according to the present invention, in either the floor use or ceiling use, the temperature difference between the upper portion and lower portion of the light emitting portion was lower that of the conventional light source apparatus for comparison. Moreover, while in the light source apparatus according to the present invention, the difference between temperature in the floor use and that in the ceiling use was 6 degrees Celsius (128 degrees minus 122 degrees), that of the conventional light source apparatus for comparison was 26 degrees Celsius (166 degrees minus 140 degrees), so that it is understood that the temperature difference value is large in the conventional light source apparatus. That is, in the light source apparatus according to the present invention, the temperature difference of the light emitting portion of the discharge lamp can be made small and the small temperature difference can be maintained in either the floor use or the ceiling use. For this reason, it is possible to prevent local rise to high temperature in the discharge lamp or the inside of the concave reflecting mirror in either the floor use or the ceiling use.

In this invention, especially the structure of the lamp holding member or the air discharging hole is not limited. In addition, in the light source apparatus according to the invention, a net member can also be put on the ventilation hole and/or the air discharging hole. Thus, if the discharge lamp is destroyed or damaged, it is possible to capture the fragment generated by the breakage in the concave reflecting mirror. Thus, it is useful since it is possible to prevent the fragments for scattering to the cooling fan or inside the projector apparatus.

Although in the structure shown in FIG. 2, the cooling fan for ventilation (for blowing off) is attached to the ventilation hole of the light source apparatus, the air discharge fan may be attached near the air discharging hole.

As mentioned above, the light source apparatus according to the present invention has the ventilation member on the front face opening edge of the concave reflecting mirror, and this ventilation member has the upper side ventilation opening in which cooling air does not blow the light emitting portion of the discharge lamp and passes above the light emitting portion so as to blow the mirror face of the concave reflecting mirror directly, and the lower side ventilation opening in which the cooling air does not blow the lighting portion of the discharge lamp directly and passes below the light emitting portion so as to blow the mirror face of the concave reflecting portion, whereby it is possible to cool the concave reflecting portion and the discharge lamp even though in either the floor use or the ceiling use, the projector apparatus in which the light source apparatus according to the present invention is built is operated.

In addition, in this invention, the “floor use” is not limited to use on a floor or desk may include any use. The “ceiling use” is not limited to a case where a projector is hung from the ceiling, and may include cases where the projector is used in a state where the projector is turned upside down compared with the floor use.

Thus the present invention possesses a number of advantages or purposes, and there is no requirement that every claim directed to that invention be limited to encompass all of them.

The disclosure of Japanese Patent Application No. 2003-347982 filed on Oct. 7, 2003 including specification, drawings and claims is incorporated herein by reference in its entirety.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

1. A light source apparatus for a projector capable of being operated in floor use and in ceiling use, in which a discharge lamp having a light emitting portion is horizontally disposed in a neck portion of a concave reflecting mirror whose front face opening is covered by light transmitting glass and an optical axis L of the concave reflecting mirrors is approximately in agreement with an arc direction of the discharge lamp,
wherein mercury of 0.15 mg/mm³ or more is enclosed in the discharge lamp,
a ventilation hole is provided in one side portion of the front face opening of the concave reflecting mirror, and an air discharging hole is provided in other side portion of the front face opening of the concave reflecting mirror, and
the ventilation hole comprises an upper side ventilation opening in which cooling air from the upper side ventilation opening passes above the light emitting portion of the discharge lamp so as not to directly blow the light emitting portion, and directly blows a mirror face of the concave reflecting mirror, and a lower side ventilation opening in which cooling air from the lower side ventilation opening passes below the light emitting portion so as not to directly blow the light emitting portion of the discharge lamp, and directly blows the mirror face of the concave reflecting mirror.

2. The light source apparatus according to claim 1, wherein the ventilation hole is provided in a ventilation member which fits in an edge of the front face opening of the concave reflecting mirror.

3. A light source apparatus for a projector capable of being used in a floor use and in a ceiling use, comprising:
a discharge lamp having a neck portion and a light emitting portion,
a concave reflecting mirror having a neck portion, in which the discharge lamp is disposed in the neck portion of the concave reflecting mirror, and
a ventilation member having at lease one ventilation opening in which cooling air from the upper side ventilation opening passes along the light emitting portion of the discharge lamp so as not to directly blow the light emitting portion and directly blows a mirror face of the concave reflecting mirror.

4. The light source apparatus according to claim 3, wherein the at least one ventilation opening comprises an upper side ventilation opening in which cooling air from the upper side ventilation opening passes above the light emitting portion of the discharge lamp so as not to directly blow the light emitting portion, and directly blows a mirror face of the concave reflecting mirror, and a lower side ventilation opening in which cooling air from the lower side ventilation opening passes below the light emitting portion so as not to directly blow the light emitting portion of the discharge lamp, and directly blows the mirror face of the concave reflecting mirror.
